(19) United States
(12) Patent Application Publication
(10) Pub. No.: US 2024/0335943 A1
(43) Pub. Date: Oct. 10, 2024

(54) SYSTEMS AND METHODS FOR PROCESSING A WORKSURFACE

(71) Applicant: 3M INNOVATIVE PROPERTIES COMPANY, St. Paul, MN (US)

(72) Inventors: Daniel M. Bodily, Woodbury, MN (US); Brett R. Hemes, Woodbury, MN (US); Xin Dong, Woodbury, MN (US)

(21) Appl. No.: 18/579,411

(22) PCT Filed: Jul. 20, 2022
(86) PCT No.: PCT/IB2022/056719

§ 371 Date: Jan. 15, 2024

Related U.S. Application Data
(60) Provisional application No. 63/203,407, filed on Jul. 21, 2021.

(51) Int. Cl. B25J 9/16; B25J 11/00

(52) U.S. Cl. CPC B25J 9/1664; B25J 9/1684; B25J 11/0065

(57) ABSTRACT

A robotic system is presented that includes a surface inspection system that receives a plurality of sampled points within a region of a worksurface. The system also includes a robotic arm, coupled to a surface processing tool, the robotic repair arm being configured to cause the surface processing tool to engage the region of the worksurface. The system also includes a process mapping system configured to, based on the plurality of sampled points: approximate a surface topography of the region of the worksurface, modify a trajectory for the robotic arm, based on the approximated surface topography, and generate a control signal for the robotic arm that includes a path for the robotic arm into the region.

### BACKGROUND

Clear coat repair is one of the last operations to be automated in the automotive original equipment manufacturing (OEM) sector. Techniques are desired for automating this process as well as other surface processing applications, including paint applications (e.g., primer sanding, clear coat defect removal, clear coat polishing, etc.), adhesive dispensing, film wrapping applications, or material removal systems that are amenable to the use of abrasives and/or robotic inspection and repair. Defect repair presents many challenges for automation.

### SUMMARY

A robotic system is presented that includes a surface inspection system that receives a plurality of sampled points within a region of a worksurface. The system also includes a robotic arm, coupled to a surface processing tool, the robotic repair arm being configured to cause the surface processing tool to engage the region of the worksurface. The system also includes a process mapping system configured to, based on the plurality of sampled points: approximate a surface topography of the region of the worksurface, modify a trajectory for the robotic arm, based on the approximated surface topography, and generate a control signal for the robotic arm that includes a path for the robotic arm into the region.

Systems and methods herein may increase the ability of robotic surface processing units to accomplish surface processing operations on worksurfaces that are not flat—for example surfaces with edges or curvature. This may increase overall surface processing efficiency and reduce the number of operations that must be completed manually.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a schematic of a robotic surface processing system in which embodiments of the present invention are useful.

FIG. 2 illustrates a method of robotic defect repair in which embodiments of the present invention may be useful

FIG. 3 illustrates a worksurface with multiple surface features in which embodiments herein may be useful.

FIG. 4 illustrates a method of processing a worksurface in accordance with embodiments herein.

FIG. 5 illustrates a method of identifying surface topography on a worksurface in accordance with embodiments herein.

FIG. 6 illustrates a process mapping system in accordance with embodiments herein.

FIGS. 7A-7C illustrate movement of a robotic repair unit over a surface feature.

FIG. 8 is a repair strategy generation system architecture.

FIGS. 9-11 show examples of computing devices that can be used in embodiments shown in previous Figures.

FIGS. 12-13 illustrate examples of surface processing calculations.

FIGS. 14A-14C illustrates the results of mathematically modeling a worksurface with a surface feature with a small set of points.

### DETAILED DESCRIPTION

Recent advancements in imaging technology and computational systems has made feasible the process of clear coat inspection at production speeds. In particular, stereo deflectometry has recently been shown to be capable of providing images and locations of paint and clear coat defects at appropriate resolution with spatial information (providing coordinate location information and defect classification) to allow subsequent automated spot repair. As automated imaging of worksurfaces improves, it is equally desired to improve the ability to automatically process worksurfaces. For example, in the case of clear coat repair, it is desired to repair detected defects, using a robotic repair system, with as little manual intervention as possible. However, as discussed herein, a worksurface exhibiting a high degree of curvature (one that deviates significantly from being a flat surface) is particularly challenging to process with a robotic system. Additionally, the presence of sharp surface features (tight bends, grooves, etc.) near the desired repair region can further complicate efforts to perform an automated repair. While humans intuitively know how to change their approach to deal with a convex or concave surfaces or edges on a surface, robotic systems have to both be informed about surface features and trained how to adjust preprogrammed trajectories to accommodate the surface feature, when detected. The systems and methods herein may be useful in any surface processing application in which a surface processing task must be mapped to a surface that exhibits significant curvature and/or surface features.

As used herein, the term “vehicle” is intended to cover a broad range of mobile structures that receive at least one coat of paint or clear coat during manufacturing. While many examples herein concern automobiles, it is expressly contemplated that methods and systems described herein are also applicable to trucks, trains, boats (with or without motors), airplanes, helicopters, etc. Additionally, while vehicles are described as examples where embodiments herein are particularly useful, it is expressly contemplated that some systems and methods herein may apply to surface processing in other industries, such as painting, adhesive processing, or material removal, such as sanding or polishing wood, plastic, paint, etc.

The term “paint” is used herein to refer broadly to any of the various layers of e-coat, filler, primer, paint, clear coat, etc. of the vehicle that have been applied in the finishing process. Additionally, the term “paint repair” involves locating and repairing any visual artifacts (defects) on or within any of the paint layers. In some embodiments, systems and methods described herein use clear coat as the target paint repair layer. However, the systems and methods presented apply to any particular paint layer (e-coat, filler, primer, paint, clear coat, etc.) with little to no modification

As used herein, the term “defect” refers to an area on a worksurface that interrupts the visual aesthetic. For example, many vehicles appear shiny or metallic after painting is completed. A “defect” can include debris trapped within one or more of the various paint layers on the work surface. Defects can also include smudges in the paint, excess paint including smears or dripping, as well as dents.

Paint repair is one of the last remaining steps in the vehicle manufacturing process that is still predominantly manual. Historically this is due to two main factors, lack of sufficient automated inspection and the difficulty of automating the repair process itself. Humans interacting with a surface have an instinctive understanding of how to accommodate surface curvature, edges or other features. Robotic surface processing systems require training.

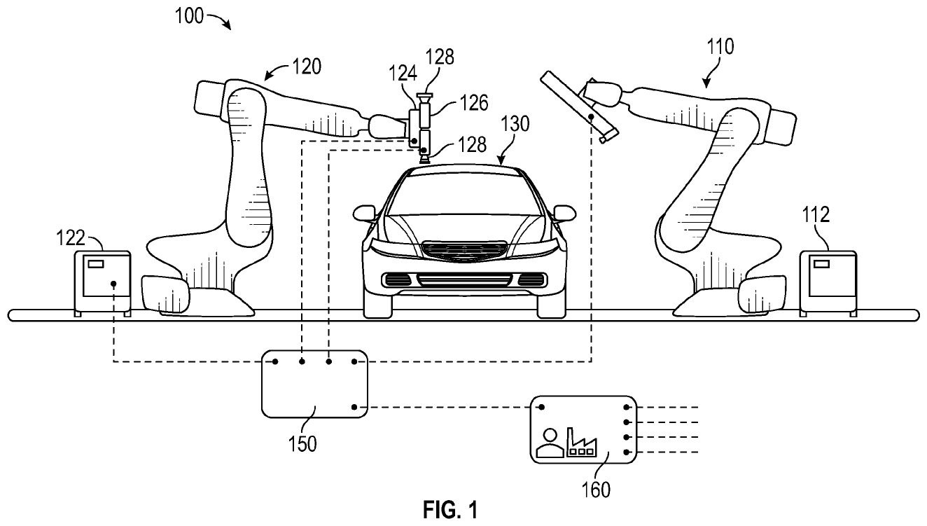

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two processing tools 128. However, other arrangements are also expressly contemplated.

The current state of the art in vehicle paint repair is to use fine abrasive and/or polish systems to manually sand/polish out the defects, with or without the aid of a power tool, while maintaining the desirable finish (e.g., matching specularity in the clear coat).

An expert human executing such a repair leverages many hours of training while simultaneously utilizing their senses to monitor the progress of the repair and make changes accordingly. Such sophisticated behavior is hard to capture in a robotic solution with limited sensing.

Additionally, abrasive material removal is a pressure driven process while many industrial manipulators, in general, operate natively in the position tracking/control regime and are optimized with positional precision in mind. The result is extremely precise systems with extremely stiff error response curves (i.e., small positional displacements result in very large corrective forces) that are inherently bad at effort control (i.e., joint torque and/or Cartesian force). Closed-loop force control approaches have been used (with limited utility) to address the latter along with more recent (and more successful) force controlled flanges that provide a soft (i.e., not stiff) displacement curve much more amenable to sensitive force/pressure-driven processing. The problem of robust process strategy/control, however, remains and is the focus of this work.

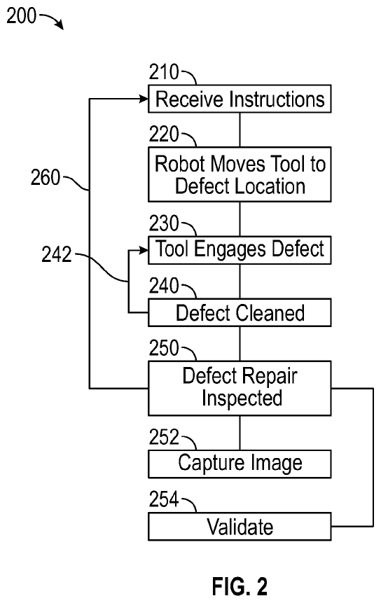

FIG. 2 illustrates a method of robotic defect repair in which embodiments of the present invention may be useful. Method 200 is an overview of how a robotic repair system repairs a defect in accordance with at least some embodiments described herein.

In block 210, instructions are received from a robot controller, such as application controller 150 in FIG. 1, for example. The instructions include movement instructions for different components of a robotic repair unit, such as a force control unit, end effector motor or tool movement patterns, etc.

In block 220, a robotic motion controller moves an abrasive article, mounted to a tool, in place to prepare to engage a defect. Defect locations may be known from an inspection system or otherwise identified, for example based on a CAD file of the worksurface.

In block 230, the abrasive article engages the defect. Engaging the defect may include sanding the defect area or polishing the defect area.

In block 240, the defect area is cleaned. Cleaning may include wiping away any fluids used in sanding or polishing, as well as wiping away debris. As indicated in block 342, after a cleaning step, the tool may re-engage the defect.

In block 250, the defect area is inspected, to determine whether the repair is sufficient. If additional repair is needed, method 200 may include the robotic repair unit receiving new instructions, as indicated by arrow 260, and the method may repeat. Inspecting a defect repair may include capturing post-repair images 252, which may be presented to a repair operator or saved as needed. Inspecting may also include validating the repair, as indicated in block 254, which may include comparing pre- and post-repair images, detecting whether a defect will be visible/noticeable to the human eye, or another suitable validation technique.

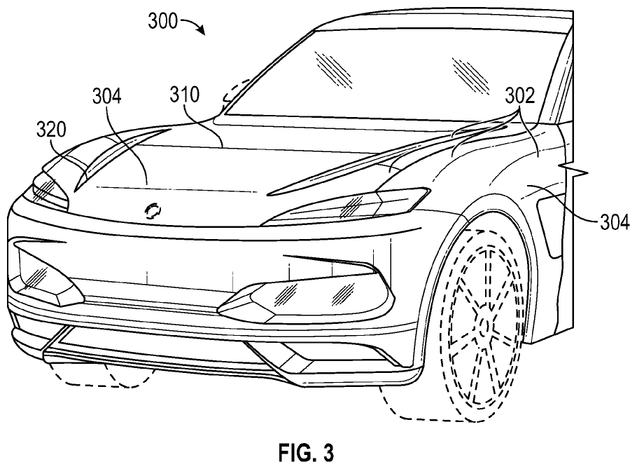

FIG. 3 illustrates a worksurface with multiple surface features in which embodiments herein may be useful. A worksurface 300, illustrated as an automobile hood in FIG. 3, includes a surface with a number of surface features 302, and some flat areas 304. Currently, defects are detected by an inspection system and provided to a human reviewer who indicates whether defects are in a repairable area or a non-repairable area. A repairable defect 310, is a defect that is in an area on worksurface 300 that a robotic repair unit can repair using repair trajectories based on a flat repair surface. In contrast, a defect too close to a surface feature 302 is deemed a manual repair defect 320, or a defect that must be repaired by hand because it cannot be done by a robotic surface processing system. Currently, in many applications, imaged defects are mapped to regions of a vehicle with a pre-proscribed routine and “repair/do not repair” criteria. For example, areas that are “tight” or on a curved (concave or convex) surface are “do not repair” areas.

It is desired to have a system or method that allows for a robotic surface processing system, such as system 100, to be able to process surfaces close to, or on areas including, surface features. Additionally, it is also desired to have a system that can determine surface topography near a defect location without access to a CAD (computer-aided design) model of a vehicle, or other worksurface, as it may not always be possible to obtain such models from vehicle manufacturers. For example, when conducting a repair in an after-market context, such as a body shop, the only way to gather surface data may be by using direct measurement.

As described herein, in some embodiments, a defect is identified and a number of points on a surface around the defect are measured. A point cloud is therefore obtained and, based on the point cloud, topography of a surface is determined. In some embodiments, based on the surface topography, a surface feature is identified. In some embodiments, a series of curvature metrics are computed at many sampled points taken from the model that has been fit from measurements. At each sampled point, these metrics are computed with respect to two orthogonal vectors (these vectors coinciding with the principle axes of curvature around which the surface is bending the most at that point). Explicitly, at each sampled point two vectors aligning with the principal axes of curvature are computed along with the associated curvature magnitudes and curvature derivatives along those axes. Because the CAD model of a surface may not be available, as described herein, mathematical modeling is needed to approximate curvature near the defect in order to identify surface features.

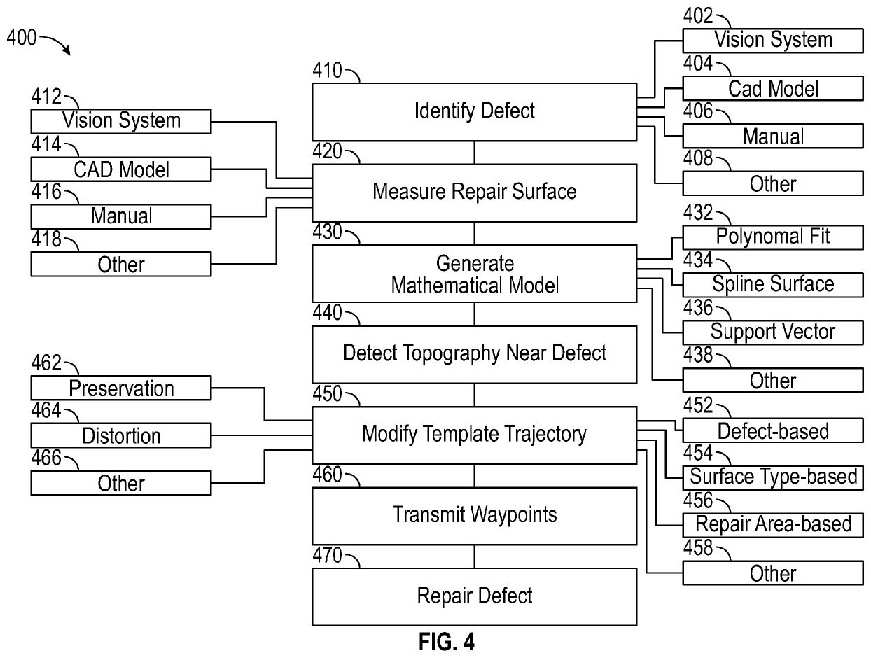

FIG. 4 illustrates a method of processing a worksurface in accordance with embodiments herein. Method 400 may be implemented into a system such as system 100. However, some steps of method 400 may be performed at different locations, for example a defect may be identified, as indicated in block 410, by an inspection system that is in a different location than a repair robot that repairs the defect in block 470. Further, a mathematical model estimating curvature may be generated locally at either the inspection system, the robotic repair location, by a local robot controller, or at a third location, such as by a cloud-based server or remote robot controller. Method 400 is discussed in the context of robotic repair of paint or clear coat defects on vehicles. However, a similar method may be useful in other industries.

In block 410, a defect is detected in a surface of a vehicle. The defect may be a dent, scratch, embedded particle in a layer of clear coat or paint, an air bubble or a smudge. The defect may be identified using a vision system, as indicated in block 402, that images the worksurface and, based on the images, identifies a defect. The defect may also be identified based on a CAD model, as indicated in block 404, for example by feeding information to a CAD model so that the defect location can be defined with regard to known surface features. In block 406, the defect may be identified, at least partially, by a manual process, such as an individual identifying a defect as a scratch, and marking it for repair such that a vision system can identify the location, or by feeding a measured location to a CAD system. Other options for identifying a defect type or location on a vehicle surface are also envisioned.

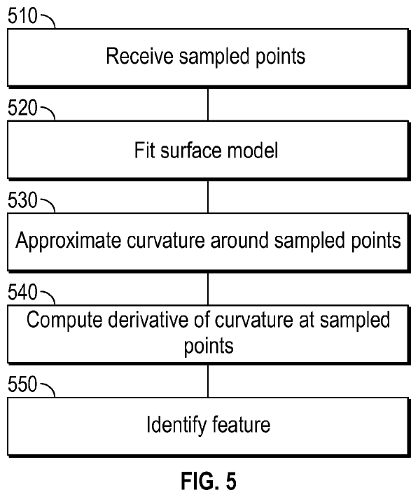

In block 420, the repair surface is measured. In some embodiments, as indicated in block 414, a CAD model provides precise measurements of surface topography at the defect location and surrounding the defect location. However, it may not always be possible to get CAD models for every worksurface. Therefore, as discussed in greater detail with respect to FIG. 5 and method 500, it may be possible to use a vision system, as indicated in block 412. It may also be possible to obtain some surface measurements manually 416, or using another method, as indicated in block 418.

In block 430, a mathematical model is generated and used to approximate surface topography at a number of points on the worksurface, for example the points measured in block 420. Model 400 may be useful for high resolution surface topography modeling as well as low resolution surface topography modeling, in different embodiments. In some embodiments, low resolution surface topography relies on a small number of surface sampling measurements, for example 25 or fewer points, 20 or fewer points, 15 or fewer points, 10 or fewer points. In an embodiment where a bivariate quadratic model is used (such as F(x,y)=ax²+by²+cxy+dx+ey), a minimum of five points is required in order to solve for the five constant values (e.g. a, b, c, d, and e). As described herein, in a low resolution scenario, a surface topography model can be fit, which can then serve as the basis onto which a surface processing operation may be mapped. In this embodiment, surface measurements used to fit the model are assumed to have been provided in a frame centered over the defect (thus no translational constant is needed in the fit model). However, it is expressly contemplated that, in some embodiments, a translational constant may be needed, if surface measurements are provided in a frame not centered over the defect. Other models may also be used, which may require more, or fewer, points to solve for each constant.

In high resolution scenarios, a greater number of surface samples are obtained, for example at least 50 points are sampled, or at least 100 points, or at least 200 points, or at least 300 points, or more. The greater number of points sampled, the more accurately the surface topography model will be in approximating the underlying surface. For example, a 6 cm diameter region may use 300 sampled points to approximate the surface topography and detect surface curvature. In high-resolution sampling scenarios, it is possible to fit a higher-order mathematical model that more accurately captures the topographical features that characterize the underlying surface (grooves, sharp bends etc.). It is then possible to use this higher order model to detect these features by identifying regions where the derivative of curvature “crosses zero” along a principal axis of curvature. It may then be possible to adapt a robot trajectory based on the detected surface feature and/or surface topography

Using a model to approximate the surface may allow a robot controller to take a very minimal set of data describing the surface. The mathematical model generated in block 430 may be sufficient to approximate the surface around the defect to allow for a custom repair operation to be tailored to that area of the worksurface. The mathematical model generated in block 430 enables a robotic controller to execute a quality repair without being fully aware of the underlying surface data. Instead, a surface processing system can receive surface measurements and use these measurements to plan and map repairs onto the target surface. The method may include any polynomial surface approximation method, as indicated in block 434, such as a quadratic fit, a cubic fit, a quartic fit, etc. Such a model allows for approximating surface properties directly from equations without needing to keep sampling. The mathematical model may, in some embodiments, be fit using least squares linear regression, as indicated in block 434. Other models may be used, as indicated in block 438. For example, when more data is available, the mathematical model may be composed of a higher dimensional representation of the surface including a surface fit using splines (B-Splines, NURBS, etc.), in one embodiment, or a support vector machine, in another embodiment.

In block 440, a feature is detected near a surface defect. The feature may be a concave surface, a convex surface, an edge, a protrusion or another surface feature that may inhibit a normal repair trajectory.

In block 450, based on a detected feature, or based on known or approximated surface curvature, or based on surface topography, a surface processing template is retrieved and modified. A repair template is a set of waypoints in a 2D plane with associated process parameters assigned at or between each point (e.g. applied force, disk speed, robot dynamics etc.). It defines a generic set of instructions for a robot to perform a surface processing operation.

The template may be modified depending on the computed curvature metrics. For example, it may be desirable that a process parameter assigned at or between two waypoints (applied force e.g.) be modified as to be proportional to the magnitude of maximum surface curvature present between these two points. Another example might be modifying (for example, by scaling up or down) the force profile applied across a set of waypoints in a repair template depending on if the surface is detected to be concave or convex at those points.

The shape of the template may also be modified depending on the approximated curvature metrics. For example, a repair template may be distorted as to warp it around a detected surface feature. This enables a robot to process defects near surface features without having to perform highly dynamic maneuvers that may cause scuffing or other undesirable effects.

Once the template is appropriately modified (both its process parameters and shape), it is then mapped from a 2D reference plane above the defect, onto the surface using the fit surface model.

The template may be retrieved based on a detected defect type or size, as indicated in block 452. The template may be retrieved based on a type of surface, for example type or color of paint, type of clearcoat, or other surface conditioning, as indicated in block 454. The template may also be retrieved based on an area of worksurface under repair, as indicated in block 456. In the example of a defect in a repair area on a hood of a car, a repair template with increased feathering at the edges may be retrieved, as opposed to if the repair area is on a lower edge of a door, where increased feathering may not be needed. The modification may preserve the repair trajectory in some capacity, as indicated in block 462, for example waypoints may undergo a transformation in which their positions are shifted only in a radial direction with respect to a central point defined in the repair template. The modification may also include a distortion metric, as indicated in block 464 to allow the defect to be addressed without interfering with the surface feature. Other modification methods may be used, as indicated in block 466, to allow a robotic repair tool to sufficiently address the defect while avoiding the surface feature.

In block 460, waypoints associated with the repair are generated and sent to a robotic repair system, such as system 100. The waypoints may be generated based on the known defect location. The waypoints may cause a robotic repair unit to move a repair tool to the defect location and follow the modified trajectory. The waypoints may be based on the approximated surface around the defect to sufficiently process, or repair, the work surface. The waypoints may be generated by mapping the modified trajectory to the surface. The mapping may include orthogonal mapping or another suitable technique.

In block 470, the robotic repair unit follows the modified trajectory to conduct a successful repair of the defect. Using method 400, a robotic repair unit can repair surfaces with no known geometry model available.

Currently, many areas on a vehicle surface are classified as “no go” zones for a robotic repair unit. Defects in areas with curved surfaces or edges require modification to repair trajectories. Humans conducting repairs can intuitively adjust how to repair a curved surface, adjusting movements, force and velocity. Systems and methods described herein may assist in modifying repair trajectories to reduce the number of “no go” zones on a vehicle. However, it is expressly contemplated that systems and methods herein may still classify some areas as unrepairable based on detected topography. Detecting an area as too difficult to repair based on detected topography obviates the need for “no-go zones” to be hand labeled and continually managed as a part may undergo design changes.

FIG. 5 illustrates a method of identifying surface features on a worksurface in accordance with embodiments herein. The use of point-cloud methods for feature detection is not unknown. For example, Kim et. al, “Extraction of Ridge and Valley Lines from Unorganized Points.” Multimedia tools and applications 63.1 (2013), pp 265-279 describes such a method. As described herein, the mathematical model of method 500 differs in how polynomial surfaces fit to a work surface and in how extremal crossings are detected. In some embodiments, method 500 relies on a sampling of points around a position of interest. These points are then used to fit many polynomial models in “patches” around the surface which are then stitched together to provide a near continuous representation of the surface for efficient interpolation. However, other methods of fitting an analytical surface to a series of points may be suitable. In one embodiment, a NURBS (Non-uniform Rational B-Splines) surface is fit to a set of measurements and then used to compute curvature metrics (principal axes of curvature, curvature magnitude and curvature derivatives as previously discussed). Other methods may also be suitable.

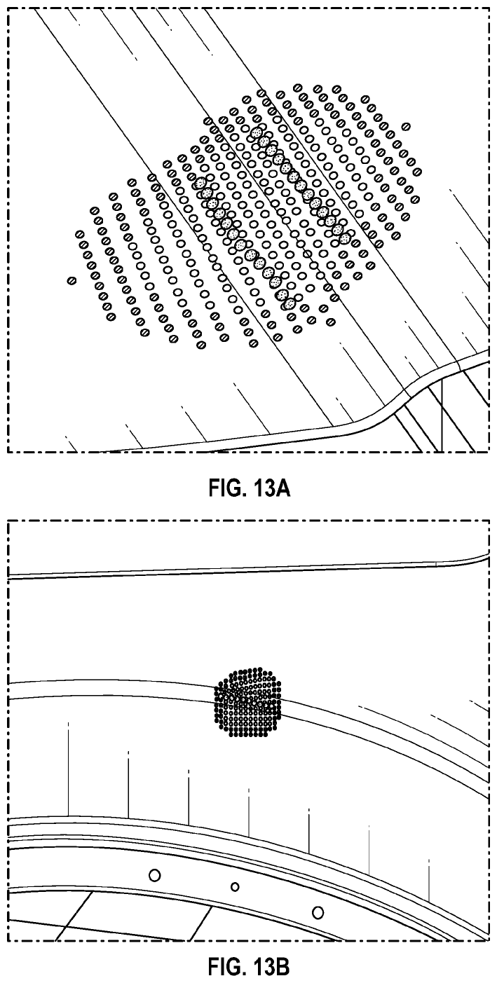

In block 510, a number of points on a surface are obtained. Samples points are obtained from a separate system, such as a vision system, for example, that samples the area around a detected defect. The points are, in one embodiment, sampled systematically based on a grid measurement as illustrated in FIG. 13A. FIG. 13A illustrates points in a planar grid projected onto a worksurface of interest used to measure the local surface topography. The points are, in one embodiment, sampled systematically based on a grid measurement as illustrated in FIG. 13A. In this example, a plane is defined at a defect location and aligned with respect to the surface normal at that location. A grid of points lying within a radius Rₘ of the central defect location (as measured in this plane) are then projected to the surface, providing a sampling of depth measurements with respect to this plane. These projected points are used to fit a surface approximation model.

In block 520, an approximation model is constructed. In one embodiment this is done by fitting a series of local approximation models, one at each sample point lying within a radius Rr of the defect point, as measured in the sampling plane described above. Each local surface model is fit using a ‘patch’ of nearby points lying within radius Rₚ of the sample point over which the patch is centered, as measured in the sampling plane. This local model is an analytical approximation of a subregion of the repair area on the underlying surface and can be used to compute curvature metrics in that subregion. In one embodiment, a local model may be composed of a bivariate polynomial function fit to a subregion using least squares regression.

Other methods may be used to fit a global approximation model directly from the entire set of measurement points taken from the surface. Such methods may employ surface approximations that are composed of splines. For example, one such approach is presented in Simple Method for Constructing NURBS Surfaces from Unorganized Points. Leal et al. Proceedings of the 19th International Meshing Roundtable pp 161-175.

In some embodiments, only local fit functions are used for each sampled point, such that no global fit is required, and surface quantities can be compared across local approximations of the surface.

In block 530, curvature metrics are approximated at a set of sample points generated from the mathematical model. These points may be sampled from the analytical surface model at a finer resolution than that of the original surface measurements. A set of metrics describing surface topography is computed at each sample point using the approximation model fit in 38. These metrics include the magnitudes (k₁, k₂) of surface curvature along the principle axes of curvature (v₁, v₂), as well as the associated derivative of curvature along each axis (e₁, e₂).

The analytical model used for this discussion is presented as Equation 1 below. However, it is expressly contemplated that other models are possible. Letting the surface be modeled by a series of bivariate, quadratic approximation functions, we obtain an implicit form each approximating function as,

$$F ( x , y ) = z ( x , y ) - ( a {x}^{2} + b {y}^{2} + c x y + d x + e y + d ) \qquad Equation 1$$

The gradient of F is taken and normalized to find a vector N that is normal to the surface, as illustrated in Equation 2, below:

$$N ( X , Y ) = \frac{( ∇ F ( x , y ) )}{\vert ∇ F ( x , y ) \vert} \qquad Equation 2$$

An Eigen Decomposition of the gradient of the normal vector (∇N) is then taken. The two eigenvectors associated with the two largest (based on absolute value) eigenvalues are vectors that lie along the principal axes of curvature. Letting H be the Hessian (matrix of second partial derivatives) of F, the associated curvature along a vector v can be computed using Equation 3 (as shown in Kim et al.).

$$k = \frac{{v}^{T} H v}{\vert ∇ F \vert} \qquad Equation 3$$

At each sampled point, there are two principle axes of curvature, a minimum and a maximum, each with an associated value of curvature. Each curvature value represents the inverse of the radius of a circle that osculates the surface along the associated axis. The principle axes of curvature (v₁, v₂) at each point may be found by taking an eigen decomposition of the gradient of the normal vector at that same point as discussed above. The metrics of k and v provide a method for analytically determining how much, and in which direction, a surface is “folding” at any given sample point.

The derivative of curvature along vector v can be computed using Equation 4 (also shown in Kim et al.).

$$e ( k , v ) = ∇ k v = \frac{{T}_{i j k} {v}^{i} {v}^{j} {v}^{k} + 3 k {H}_{i j} {v}^{i} {N}^{j}}{\vert ∇ F \vert} \qquad Equation 4$$

T is a 3×3×3 tensor of the third partial derivatives off. We compute these in both principle axes to obtain the derivatives of curvature (e₁, e₂). Equations 3 and 4 come from Kim et al. However, while the use of these equations are discussed in the context of a bivariate cubic polynomial approximation, it is expressly contemplated that these equations can be used on any analytical model by following the same steps as outlined. In doing so the polynomial, in Equation 1 would be replaced by the analytical model of choice. For example, if a NURBS surface S (x,y) has been fit from a set of measurements, then Equation 1 would be adapted to become, F(x,y)=z(x,y)−(S(x,y)), and the method would proceed as outlined.

In block 540, the derivative of curvature along each principle axis of curvature is computed at each point sampled from the analytical model.

In block 550, points where the derivative of curvature along a principle axis of curvature crosses zero are approximated. Zero crossings in the derivatives of curvature (e.g. where e₁, e₂ change signs across neighboring points) correlate with valleys and ridges, e.g. surface features, on a surface. Surface features can, therefore, be detected by comparing the local approximations of the curvature of derivatives (e₁, e₂) across sample points.

It is duly noted in the literature that the principle axes of curvature are directionally ambiguous. This can lead to random flipping of the computed eigenvectors (v₁, v₂) which in turn can lead to false feature point detections (the signs of e₁ and e₂ also flip).

To account for this, when checking if a zero crossing of the derivative of curvature (e) exists between two sample points, the associated principle directions are aligned locally. For example, if eigenvector v₁ at pt1 is not found to be within 90 degrees of eigenvector v₁ computed at a neighboring point, the representation at pt1 is flipped (v₁ and e₁ are both negated). Once they align, a change in sign of e1 compared across these neighboring points reveal an associated feature point.

After aligning axes of curvature between neighboring points, a feature point is detected if the sign of the derivative of curvature changes. The sign of the value of curvature (k) at the e-crossing indicates whether the surface feature is a ridge or a valley, and the magnitude of the value of curvature provides a metric for how sharp the ridge or valley is. For example, a feature point may be ignored if the magnitude of curvature (|k|) computed at that feature point is found to be less than a user-defined tolerance, as this point may not be significant enough to warrant special consideration when performing a repair.

When a feature point is detected to lie between two sampled points, the values of the derivate of curvature at those points are used to determine a more accurate estimate of the point of crossing, using Equation 5, below.

$${p}_{e} = \frac{\vert {e}_{2} \vert}{\vert {e}_{1} \vert + \vert {e}_{2} \vert} {p}_{1} + \frac{\vert {e}_{1} \vert}{\vert {e}_{1} \vert + \vert {e}_{2} \vert} {p}_{2} \qquad Equation 5$$

This is in contrast to Kim et. al.'s method which assigns the smallest value of the derivative of curvature to be the “detected ridge point”. With a global approximation model, it is contemplated that even more accurate methods of detecting exact crossings are conceivable. These could be done using root-solving techniques such as Newton Raphson.

For a robotic repair unit to be able to repair a curved surface, a path may be projected directly onto a CAD model that represents that surface. This assumes that the trajectory planner has full access to the CAD data and can thereby perform such path projection. In practice, these CAD files can be hard to manage due to their complexity, dynamic nature (a part might go through several redesigns for example), and the underlying intellectual property agreements that must be established before such data can be shared. Using method 500, a robotic repair unit can complete method 400 without needing the robot controller to be aware of and manage these CAD files, instead allowing sensors or an auxiliary system to provide it with sample points from which the surface is approximated locally.

Once a model approximating the surface has been fit, using method 500 for example, waypoints defining a templated robot repair trajectory can be mapped from a 2D plane onto the 3D approximation. One realization of this mapping is via orthogonal projection. Other more advanced means of mapping these path points are also conceivable including those that seek to limit radial distortion introduced by the 2D to 3D projection of the repair path.

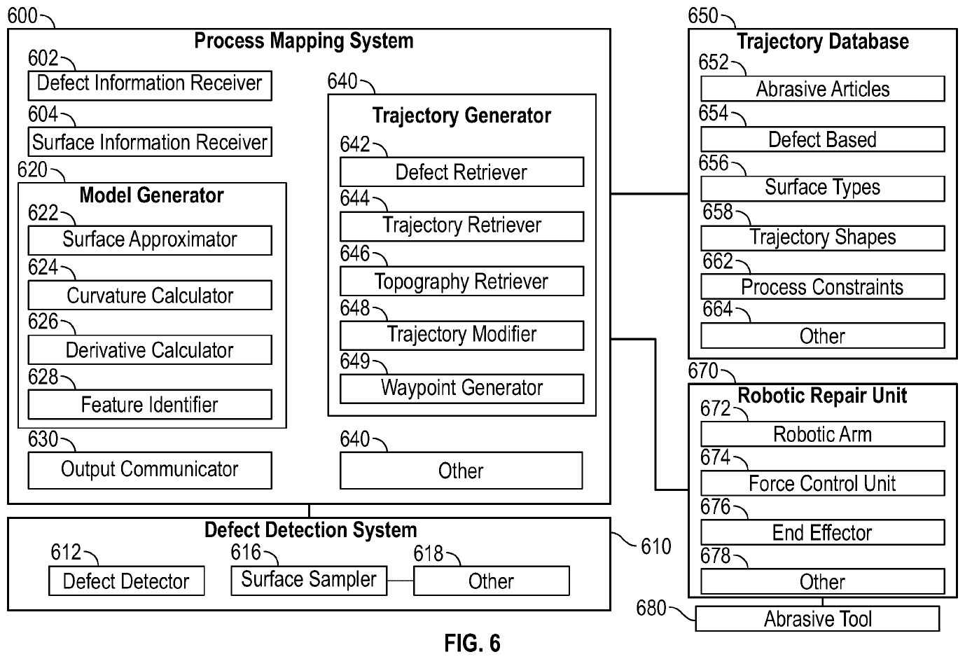

FIG. 6 illustrates a process mapping system in accordance with embodiments herein. Process mapping system 600 may be built into a robot controller of a robotic repair unit, in some embodiments. In other embodiments, process mapping system 600 may be remote from robotic repair unit 670, as indicated in FIG. 6. Additionally, FIG. 6 illustrates an embodiment where trajectory database 650 is separate and remote from process mapping system 600, however it is expressly contemplated that process mapping system 600 may be located on a sever with trajectory database 650. It is expressly contemplated that other configurations of components are envisioned than those illustrated in FIG. 6.

A defect detection system 610 detects defects on a worksurface and provides defect and surface information to process mapping system 600. Defect detection system 610 may be an imaging system as described with respect to FIG. 1. However, other systems 610 may be possible. A defect detector 612 detects defects on a worksurface, in the example of vehicle repair. However, in the embodiment of adhesive dispensing, an adhesive target area detector 612 detects or specifies where adhesive should be dispensed. In the embodiment of film wrapping, a target detector 612 detects an area where film will wrap, or areas where film may wrap unevenly. In the embodiment of material removal, a target removal area 612 detects where material should be removed from a surface. A surface sampler 616 samples a surface around the detected defect/adhesive dispensing target/target removal area. Defect detection system 610 may include other functionality 618 as well. For example, defect detection system 610 may be a camera system that images a surface before and after a defect removal/adhesive dispensation/material removal operation.

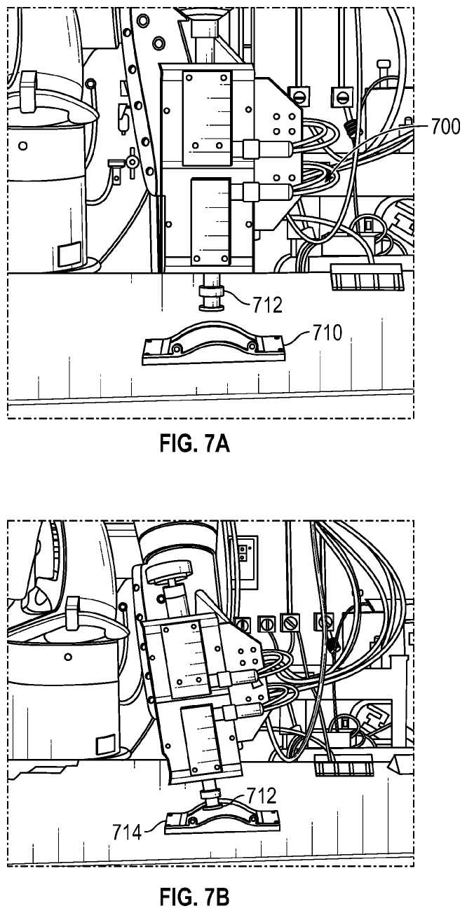

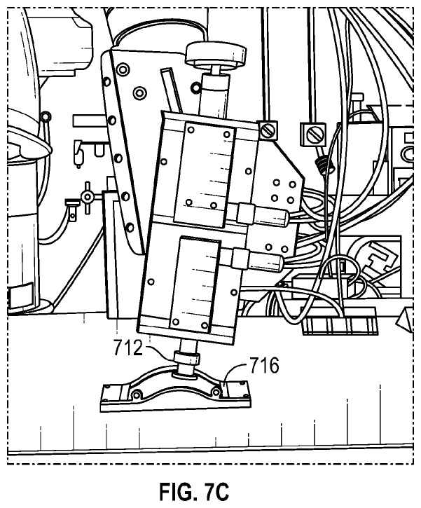

A robotic repair unit 670 is the mechanical unit responsible for implementing the repair trajectory on a worksurface. The robotic repair unit 670 includes a robotic arm 672 that moves abrasive tool 680 into position for a repair operation. Robotic arm 672 may have multiple movement mechanisms, motor-powered or otherwise, that move abrasive tool 680 through a trajectory, as illustrated in FIGS. 7A-7C. Robotic repair unit 670 may also include a force control unit 674 that applies force through an end effector to the abrasive tool 680.

A defect information receiver 602 retrieves information about a defect, such as from defect detection system 610. Defect information retriever 602 may retrieve a defect location, with respect to a CAD model, or may receive other location information.

Surface information retriever 604 retrieves surface sampling information retrieved by surface sampler 616. Based on retrieved surface sampling, model generator 620 can generate a mathematical model to approximate the curvature and detect surface features near the defect. A surface approximator 622 approximates the surface. This may be done using a polynomial approximation, a set of polynomial “patches” as discussed, an approximation using a spline-based methods (B-Splines, NURB surface, etc.), support vector machines, or another suitable approximation. Based on the surface approximation, a curvature approximator 624 determines a magnitude and direction of principal curvature at each of the sampled points. A derivative calculator 626 calculates the derivative of the curvature with respect to the principal axes of curvature at a set of sample points taken from the fit model. Based on the derivative calculations, feature identifier 628 identifies a set of feature points, for example an, set of points corresponding with a valley, a ridge, an area of increased curvature, an area of convex curvature, an area of concave curvature, an area of rapid transition of convex and concave curvature (indicating a tight groove for example), or another feature.

A trajectory generator 640 generates a modified trajectory based on surface curvature. A defect retriever 642 retrieves information about a defect, for example from defect detection system 610. Retrieved defect information may include a defect type, size, location, severity or other information that may be useful for choosing a trajectory template. A trajectory retriever 644 may retrieve a trajectory template from trajectory database 650. Trajectory database 650 may include a number of trajectories that may be selected based on defect parameters, as indicated in block 654, such as a defect type, defect location, defect size, defect severity, etc. A trajectory may also be selected based on an abrasive article 652 or tool selected. For example, the size or type of an abrasive disc or backup pad may dictate, at least to some extent, a trajectory selection. Information about a worksurface, indicated in block 656, such as the worksurface material (e.g. wood, plastic, metal, paint, clearcoat, layers thereof, etc.), may influence a trajectory selection. Similarly, process constraints 662 of robotic repair unit 670, such as a maximum force that force control unit 674 can exert, a maximum RPM of an abrasive tool, or clearance ranges needed for different components, may influence a trajectory selection. Based on known information about a defect, surface, and robotic repair unit 670, an initial trajectory shape may be selected from trajectory shapes 658, such as a spiral, a circle, elliptical, hypotrochoid, rosette, or other appropriate shape.

Based on all of the retrieved information, trajectory generator 640 modifies the received trajectory. For example, at or between waypoints, each of a number of parameters may be specified. An attack angle may be adjusted, as well as (or in addition to) end-effector velocity, RPM of a spinning tool, vibrational speed of a vibrating tool, applied force, adhesive dispensing speed, film dispensing speed, etc.

Topography retriever 646 retrieves a surface approximation from surface approximator 622, in the low resolution scenario, as well as curvature information from curvature approximator 624, and any identified features from feature identifier 628. Trajectory modifier 648 modifies the retrieved trajectory based on the surface topography and any detected curvature and surface features. The trajectory may be modified by a scalar quantity, for example shrunk or enlarged to accommodate curvature, or may be adjusted in another manner, for example stretched or compressed. Based on the modified trajectory, a number of waypoints may be generated, by waypoint generator 649. Waypoints may be generated to guide robotic arm 672 from a previous defect, or a current position, to the defect location and through the modified trajectory to complete the repair.

FIGS. 7A-7C illustrate movement of a robotic repair unit over a surface feature. In FIG. 7A, a repair robot 700 is approaching a worksurface 710, bringing tool 712 near a defect. As illustrated in FIG. 7B, tool 712 is engaging worksurface 710 at an angle on a first side 714 of the curved surface. As illustrated in FIG. 7C, tool 712 is engaging worksurface 710 on a second side 716 of the curved surface. A single trajectory may allow for robotic repair unit 700 to adjust an attack angle of tool 712 to move from first side 714 to second side 716 of the curved worksurface, addressing a defect along the illustrated surface feature that, previously, would have required manual repair.

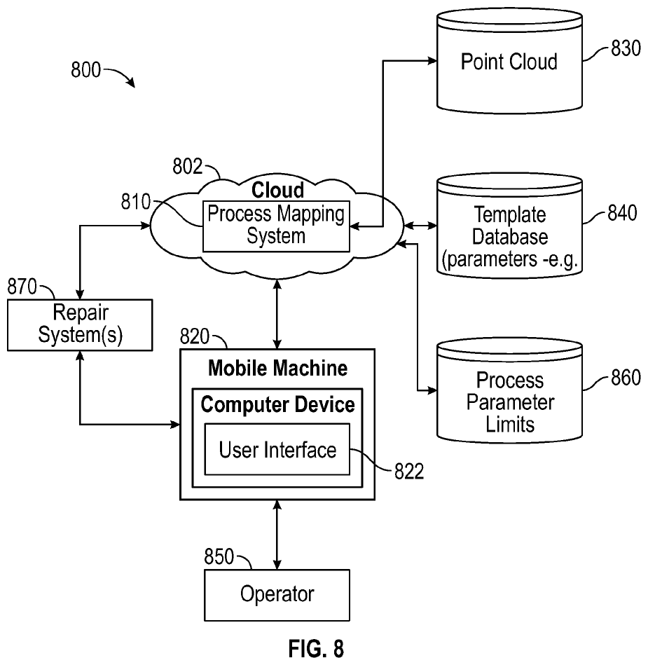

FIG. 8 is a surface process system architecture. The surface processing system architecture 800 illustrates one embodiment of an implementation of a defect detection and ranking system 810. As an example, surface process system 800 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-7 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 8, some items are similar to those shown in earlier figures FIG. specifically shows that a process mapping system 810 can be located at a remote server location 802. Therefore, computing device 820 accesses those systems through remote server location 802. Operator 850 can use computing device 820 to access user interfaces 822 as well.

FIG. 8 shows that it is also contemplated that some elements of systems described herein are disposed at remote server location 802 while others are not. By way of example, storage 830, 840 or 660 or robotic repair systems 870 can be disposed at a location separate from location 802 and accessed through the remote server at location 802. Regardless of where they are located, they can be accessed directly by computing device 820, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

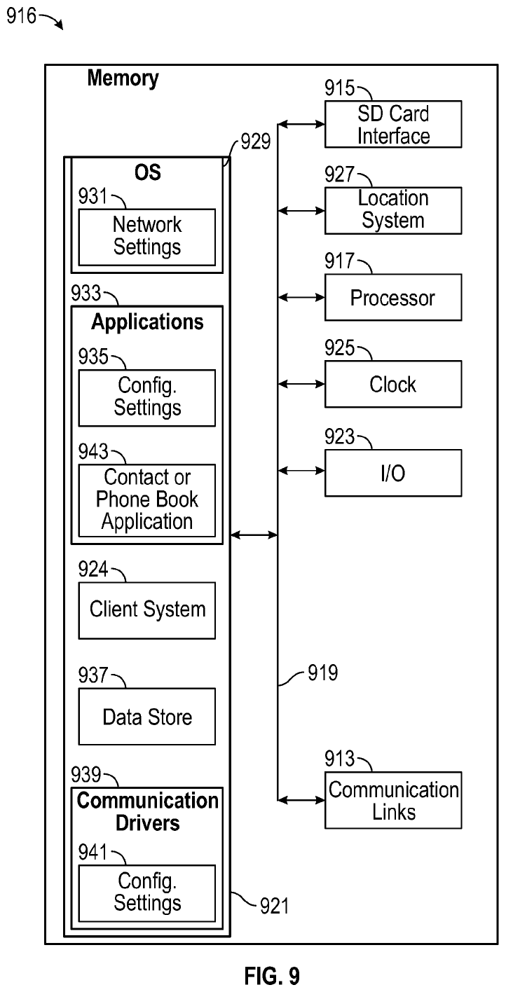

FIGS. 9-12 show examples of computing devices that can be used in embodiments shown in previous Figures.

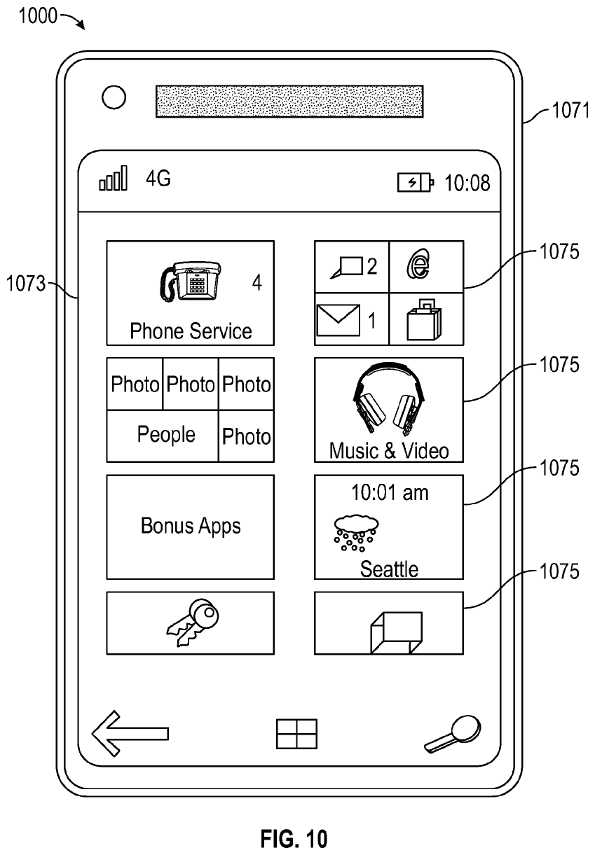

FIG. 9 is a simplified block diagram of one illustrative example of a handheld or mobile computing device that can be used as a user's or client's handheld device 16 (e.g., as computing device 820 in FIG. 9), in which the present system (or parts of it) can be deployed. For instance, a mobile device can be deployed in the operator compartment of computing device 820 for use in generating, processing, or displaying the data. FIG. 10 is another example of a handheld or mobile device.

FIG. 9 provides a general block diagram of the components of a client device 916 that can run some components shown and described herein. Client device 916 interacts with them, or runs some and interacts with some. In the device 916, a communications link 913 is provided that allows the handheld device to communicate with other computing devices and under some embodiments provides a channel for receiving information automatically, such as by scanning. Examples of communications link 913 include allowing communication though one or more communication protocols, such as wireless services used to provide cellular access to a network, as well as protocols that provide local wireless connections to networks.

In other examples, applications can be received on a removable Secure Digital (SD) card that is connected to an interface 915. Interface 915 and communication links 913 communicate with a processor 1617 (which can also embody a processor) along a bus 919 that is also connected to memory 1621 and input/output (I/O) components 923, as well as clock 925 and location system 927.

I/O components 923, in one embodiment, are provided to facilitate input and output operations and the device 916 can include input components such as buttons, touch sensors, optical sensors, microphones, touch screens, proximity sensors, accelerometers, orientation sensors and output components such as a display device, a speaker, and or a printer port. Other I/O components 923 can be used as well.

Clock 925 illustratively comprises a real time clock component that outputs a time and date. It can also provide timing functions for processor 917.

Illustratively, location system 927 includes a component that outputs a current geographical location of device 916. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 921 stores operating system 929, network settings 931, applications 933, application configuration settings 935, data store 937, communication drivers 939, and communication configuration settings 941. Memory 921 can include all types of tangible volatile and non-volatile computer-readable memory devices. It can also include computer storage media (described below). Memory 921 stores computer readable instructions that, when executed by processor 917, cause the processor to perform computer-implemented steps or functions according to the instructions. Processor 1617 can be activated by other components to facilitate their functionality as well.

FIG. 10 shows that the device can be a smart phone 1001. Smart phone 1071 has a touch sensitive display 1073 that displays icons or tiles or other user input mechanisms 1075. Mechanisms 1075 can be used by a user to run applications, make calls, perform data transfer operations, etc. In general, smart phone 1071 is built on a mobile operating system and offers more advanced computing capability and connectivity than a feature phone.

Note that other forms of the devices 1016 are possible.

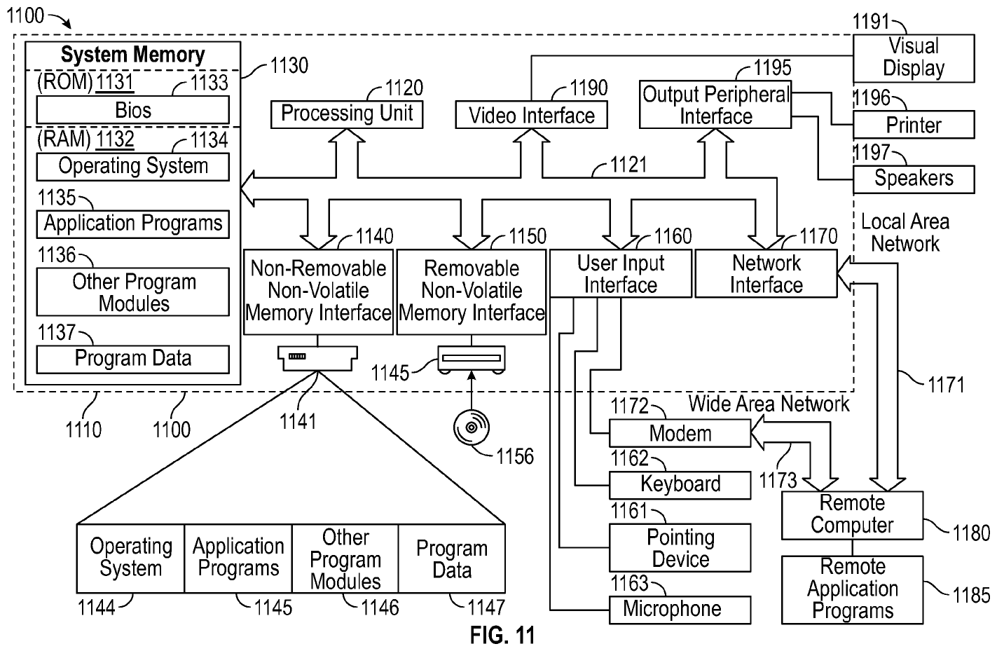

FIG. 11 is a block diagram of a computing environment that can be used in embodiments shown in previous Figures.

FIG. 11 is one example of a computing environment in which elements of systems and methods described herein, or parts of them (for example), can be deployed.

With reference to FIG. 11, an example system for implementing some embodiments includes a general-purpose computing device in the form of a computer 1110. Components of computer 1110 may include, but are not limited to, a processing unit 1120 (which can comprise a processor), a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures. Memory and programs described with respect to systems and methods described herein can be deployed in corresponding portions of FIG. 11.

Computer 1110 typically includes a variety of computer readable media. Computer readable media can be any available media that can be accessed by computer 1110 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1110. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1130 includes computer storage media in the form of volatile and/or nonvolatile memory such as read only memory (ROM) 1131 and random access memory (RAM) 1132. A basic input/output system 1133 (BIOS) containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable and volatile/nonvolatile computer storage media. By way of example only, FIG. 11 illustrates a hard disk drive 1141 that reads from or writes to non-removable, nonvolatile magnetic media, nonvolatile magnetic disk 1152, an optical disk drive 1155, and nonvolatile optical disk 1156. The hard disk drive 1141 is typically connected to the system bus 1121 through a non-removable memory interface such as interface 1140, and optical disk drive 1155 are typically connected to the system bus 1121 by a removable memory interface, such as interface 1150.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137.

A user may enter commands and information into the computer 1110 through input devices such as a keyboard 1162, a microphone 1163, and a pointing device 1161, such as a mouse, trackball or touch pad. Other input devices (not shown) may include a joystick, game pad, satellite receiver, scanner, or the like. These and other input devices are often connected to the processing unit 1120 through a user input interface 1160 that is coupled to the system bus, but may be connected by other interface and bus structures. A visual display 1191 or other type of display device is also connected to the system bus 1121 via an interface, such as a video interface 1190. In addition to the monitor, computers may also include other peripheral output devices such as speakers 1197 and printer 1196, which may be connected through an output peripheral interface 1195.

The computer 1110 is operated in a networked environment using logical connections, such as a Local Area Network (LAN) or Wide Area Network (WAN) to one or more remote computers, such as a remote computer 1180.

When used in a LAN networking environment, the computer 1110 is connected to the LAN 1171 through a network interface or adapter 1170. When used in a WAN networking environment, the computer 1110 typically includes a modem 1172 or other means for establishing communications over the WAN 1173, such as the Internet. In a networked environment, program modules may be stored in a remote memory storage device. FIG. 11 illustrates, for example, that remote application programs 1185 can reside on remote computer 1180.

A robotic system is presented that includes a surface inspection system that receives a plurality of sampled points within a region of a worksurface. The system also includes a robotic arm, coupled to a surface processing tool, the robotic repair arm being configured to cause the surface processing tool to engage the region of the worksurface. The system also includes a process mapping system configured to, based on the plurality of sampled points: approximate a surface topography of the region of the worksurface, modify a trajectory for the robotic arm, based on the approximated surface topography, and generate a control signal for the robotic arm that includes a path for the robotic arm into the region.

The robotic system may be implemented such that the worksurface is a vehicle.

The robotic system may be implemented such that the surface inspection system includes a vision system.

The robotic system may be implemented such that the vision system includes a camera.

The robotic system may be implemented such that the region contains a defect, and wherein the surface engaging tool is a material removal tool.

The robotic system may be implemented such that the surface processing tool is a sander or polishing tool.

The robotic system may be implemented such that the sampled points are identified using a 3D model of the vehicle.

The robotic system may be implemented such that the 3D model is a CAD model.

The robotic system may be implemented such that the sampled points are identified by measuring the vehicle.

The robotic system may be implemented such that the trajectory is mapped onto the approximated surface.

The robotic system may be implemented such that the surface topography is approximated from less than 10 sampled points.

The robotic system may also include approximating curvature at each of the sampled points in the region. The approximated surface topography includes the approximated curvature.

The robotic system may be implemented such that approximating curvature includes sampling the approximated surface.

The robotic system may be implemented such that the sampled points are first sampled points and sampling the approximated surface includes sampling a second set of sampled points. Each of the second set of points are samples taken of the model around each of the first sampled points.

The robotic system may be implemented such that the number of sampled points is less than 50.

The robotic system may also include calculating the derivative of the approximated curvature at each of the sampled points; and identifying a surface feature in the region based on the derivative calculation.

The robotic system may be implemented such that the number of sampled points is greater than 100.

The robotic system may be implemented such that the path includes a series of waypoints through the region.

The robotic system may be implemented such that the trajectory is selected based on a defect size, defect location, defect type or defect severity.

The robotic system may be implemented such that the trajectory is modified based on a surface feature identified within the approximated surface topography.

The robotic system may be implemented such that the trajectory is stretched or compressed.

The robotic system may be implemented such that the trajectory shape is a circle, oval, rosette, spiral or hypotrochoid.

The robotic system may be implemented such that the trajectory is proportionately enlarged or reduced.

The robotic system may be implemented such that the modified trajectory includes a modified tool force, disk speed, or tool speed.

The robotic system may be implemented such that the robotic arm executes the control signal and follows the path.

The robotic system may be implemented such that the approximation is a polynomial approximation.

The robotic system may be implemented such that the polynomial approximation is a cubic polynomial.

The robotic system may be implemented such that the number of sampled points is less than 20.

A surface feature detection system for detecting a feature on a worksurface is presented that includes a surface sampling receiver that receives a plurality of surface samples from a surface imaging system. The system also includes a surface approximator that approximates the surface at each of the plurality of surface samples using an approximation. The system also includes a curvature approximator that approximates the curvature and derivative of curvature at each of the plurality of surface samples. The system also includes a feature detector that, based on a derivative of the curvature approximation at each of the surface samples, identifies a point of zero-crossing in the derivative of curvature as a detected feature point.

The system may also include a communication component that transmits an indication of the detected feature to a display component.

The system may be implemented such that the detected feature is overlayed over the approximated surface.

The system may be implemented such that the detected feature is overlayed over the sampled surfaces.

The system may be implemented such that the plurality of surface samples are received from a CAD model.

The system may be implemented such that the plurality of surface samples are received from a surface measurement system.

The system may be implemented such that the surface measurement system includes a camera.

The system may be implemented such that the approximation is a polynomial approximation.

The system may be implemented such that the polynomial approximation is a cubic polynomial.

The system may be implemented such that the plurality of surface samples are within a radius of a target area on the worksurface.

The system may be implemented such that the worksurface is a vehicle surface, the target area includes a defect, and wherein the surface feature is a valley, a ridge, an area of increased curvature, an area of convex curvature, an area of concave curvature, an area of rapid transition of convex and concave curvature on the vehicle surface proximate the defect.

The system may be implemented such that the plurality of surface samples are received from a vision system that images the worksurface.

The system may also include a communication component that outputs the detected feature to a trajectory modifier that modifies a repair trajectory to address the defect.

The system may be implemented such that a shape of the trajectory is stretched or compressed based on the detected feature.

The system may be implemented such that the trajectory is proportionately enlarged or reduced.

The system may be implemented such that the trajectory modifier maps a trajectory template onto the approximated surface to obtain the modified trajectory.

The system may also include a repair evaluator that, based on the approximated curvature and approximated derivative of curvature, classifies an area as robotically repairable or not robotically repairable.

The system may be implemented such that, if the area is robotically repairable, a trajectory modifier generates a trajectory through the area.

The system may be implemented such that the trajectory includes a plurality of waypoints, and, at each of the plurality of waypoints, a force and velocity of a surface processing tool contacting the worksurface.

The system may be implemented such that the surface processing tool is a rotating tool, and wherein each of the plurality of waypoints includes a rotation speed.

The system may be implemented such that the surface is approximated from less than 10 sampled points.

The system may be implemented such that approximating curvature includes sampling the approximated surface.

The system may be implemented such that the sampled areas are first sampled areas sampling the approximated surface includes sampling a second set of sampled areas, wherein each of the second set of areas are samples taken of the model around each of the first sampled areas.

The system may be implemented such that the number of sampled areas is less than 50.

The system may be implemented such that the number of sampled areas is greater than 100.

The system may be implemented such that the number of sampled areas is less than 20.

The system may be implemented such that the modified trajectory includes a modified tool force, disk speed, or tool speed.

The system may be implemented such that the trajectory template is selected based on a defect size, defect location, defect type or defect severity.

The system may be implemented such that the trajectory is modified based on the identified surface feature.

A method of removing material from a worksurface is presented that includes identifying a target area on the worksurface for material removal, sampling a surface around the target area on the worksurface, modeling the surface and, based on the model, detecting a surface topography, modifying a surface processing trajectory based on the detected surface topography. The surface processing trajectory includes a movement path through the target area. The method also includes transmitting a control signal to a robotic material removal system, wherein the control signal includes the modified trajectory.

The method may be implemented such that modeling the surface includes: approximating the surface at each of a plurality of sampled surface locations.

The method may be implemented such that the surface approximation is a polynomial approximation.

The method may be implemented such that the target area includes a defect.

The method may be implemented such that the worksurface includes a vehicle.

The method may be implemented such that sampling a surface includes a vision system imaging the surface.

The method may be implemented such that the vision system includes a camera.

The method may be implemented such that the surface processing trajectory includes a force profile along the movement path.

The method may be implemented such that the modified surface processing trajectory includes a modified movement path through the target area.

The method may be implemented such that the modified movement path has a smaller area than the original movement path.

The method may be implemented such that the modified movement path is linearly translated from the original movement path.

The method may be implemented such that the modified movement path is stretched or compressed from the original movement path.

The method may be implemented such that the modified movement path includes an attack angle for a surface engaging tool of the robotic material removal system.

The method may be implemented such that the vision system identifies the target area as including a defect.

The method may also include detecting a surface feature from the surface topography

The method may also include, based on the detected surface topography, classifying the target area as robotically repairable.

The method may be implemented such that the surface engaging tool is a material removal tool.

The method may be implemented such that the surface processing tool is a sander or polishing tool.

The method may be implemented such that the surface topography is sampled from a 3D model of the vehicle.

The method may be implemented such that the 3D model is a CAD model.

The method may also include approximating the curvature at each of the sampled surface locations; and detecting a surface feature based on a derivative value of the approximated curvature.

The method may be implemented such that the surface topography is approximated from less than 10 sampled surface locations.

The method may be implemented such that the surface topography is approximated from less than 20 sampled surface locations.

The method may be implemented such that the surface topography is approximated from less than 50 sampled surface locations.

The method may be implemented such that the surface topography is approximated from more than 100 sampled surface locations.

The method may be implemented such that approximating curvature includes sampling the approximated surface.

The method may be implemented such that the sampled areas are first sampled areas sampling the approximated surface includes sampling a second set of sampled areas. Each of the second set of areas are samples taken of the model around each of the first sampled areas.

The method may be implemented such that a template surface processing trajectory is selected based on a defect size, defect location, defect type or defect severity.

The method may be implemented such that a template surface processing trajectory is selected based on an identified surface feature.

### EXAMPLES

### Example 1

Edges are sought on the analytical surface defined by:

$$S ( x . y ) = 0.02 cos \frac{π x}{{R}_{m}} + 0.02 sin \frac{π y}{{R}_{m}} \qquad Equation 6$$

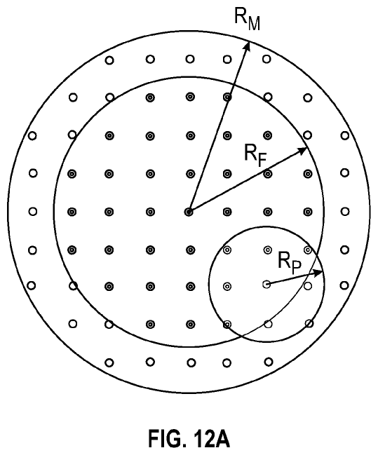

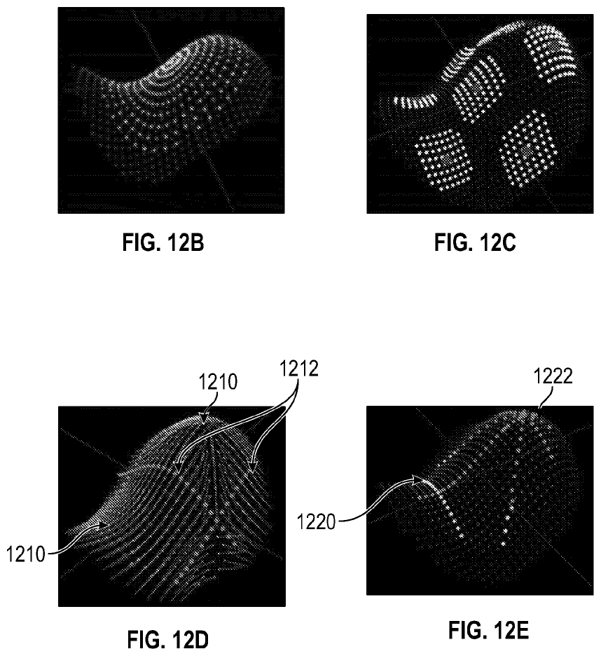

R_{M} (radius of overall circle) is set to 0.06 and R_{P} (path radius) is set to 0.015. Measurement points x are spaced a distance of dₓ=0.003 from each other in a grid pattern, as illustrated in FIG. 12A. The projection of these points on the analytical surface are shown in FIG. 12B. The lighter points show a sample of interpolation points each found by evaluating local polynomial patches fit from the original sampling set. FIG. 12A illustrates how local models may be patched together to approximate the shape of the underlying surface. FIG. 12C illustrates a sampling of patches, each used to fit a polynomial model that is then used to locally approximate the surface. FIG. 12D illustrates vₘₐₓ plotted at every point. Points 1210 illustrate umbilical points where the surface is locally spherical in nature. Points 1212 correlate to areas where curvature magnitudes are near zero. The intersection of points 1210 and 1212 illustrate areas where the surface is locally flat. In FIG. 12E, the detected crossings of the derivatives of curvature are shown. Points 1220 are the illustrated “valleys” and points 1222 are the “ridges” on the surface.

### Example 2

High resolution sampling is performed on a surface with unknown topography. To do this, points are sampled from a CAD model that represents a smooth, well behaved surface. The distance between sample points x is chosen to be dₓ=0.003. R_{M}=0.03 and R_{P}=0.0075. The sampling plane is taken to be aligned with the surface normal at the center sampled point on the CAD geometry. FIGS. 13A and 13B illustrate how the algorithm was used to detect features of the underlying surface.

The strength of the algorithm illustrated in Example 2 is the ability to capture the underlying qualities of a surface with a set of measurements from the surface. A system can scan or otherwise take measurements from a surface and detect regions that are highly dynamic in nature, and then quantify the dynamic variability using curvature measurements as described herein. This allows surface features to be detected robustly and efficiently. Feature points detected by the algorithms discussed here are accurate to the resolution used in the sampling grid, which is illustrated by the slight S-curve of feature points illustrated in FIG. 13A. Higher resolution sampling of the fit model will improve the accuracy of detected ridge lines with respect to the fit model.

### Example 3

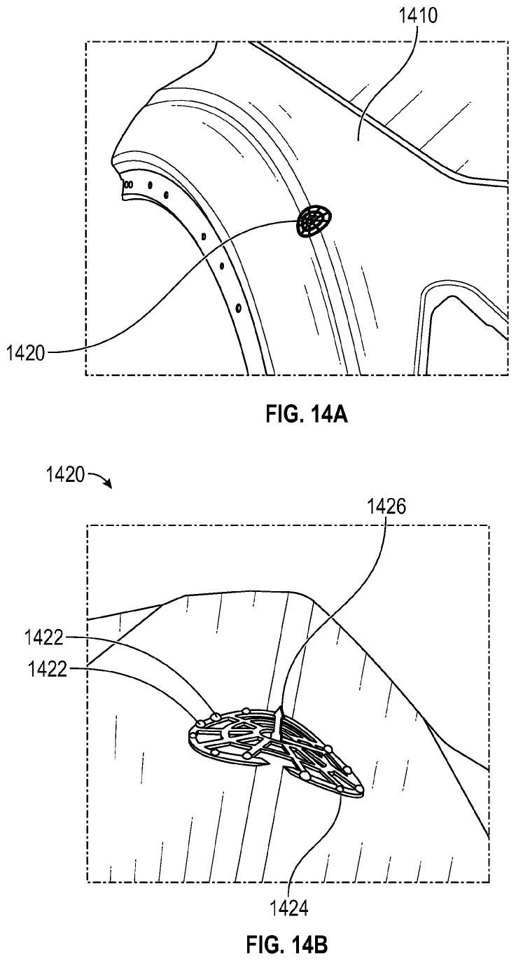

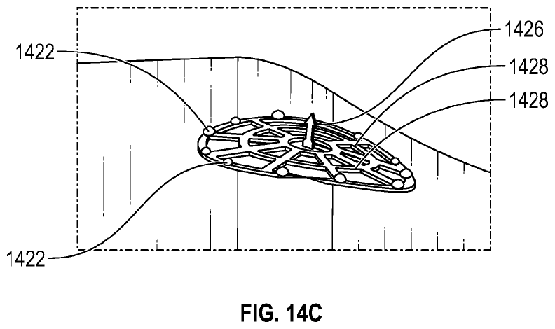

FIGS. 14A-14C illustrates the results of mathematically modeling a worksurface with a surface feature with a small set of points. A set of measurements 1402, 1404 is sampled on a CAD surface 1400 representing a vehicle. An analytical model is fit to these points and the derivative of curvature is measured at each sample point. Where the derivative of curvature flips signs a feature line 1402 is detected. Repairs near this region may then be transformed either to avoid this feature line, or to run parallel and/or perpendicular to it. Path speed, tool force and tool velocity may also be adjusted.

FIG. 14A illustrates a sampled surface 1420 on a worksurface 1410. Worksurface 1410 is illustrated in FIGS. 14A-14C as a vehicle with a defect located near a ridge over a wheel well. FIGS. 14B-14C illustrate different views of the sampled area. Sampled points 1422, as well as outer ring 624 are received from a sampling system, such as the vision system of FIG. 1. The mathematical surface fit is represented by the web 1428. The model is locally accurate and diverges further away from the defect. Arrow 1426 indicates normal from the surface. In some embodiments, points 1422 are taken from the frame of reference of normal 1426. however, it is contemplated that, in other embodiments, the point cloud 1422 could be taken from any frame of reference. If points 1422 are taken in a different frame of reference, then a normal plane with respect to the defect to correct.

1. A robotic system comprising:
a surface inspection system that receives a plurality of sampled points within a region of a worksurface;
a robotic arm, coupled to a surface processing tool, the robotic repair arm being configured to cause the surface processing tool to engage the region of the worksurface; and
a process mapping system configured to, based on the plurality of sampled points:
approximate a surface topography of the region of the worksurface;
modify a trajectory for the robotic arm, based on the approximated surface topography; and
generate a control signal for the robotic arm that comprises a path for the robotic arm into the region.

2. The robotic system of claim 1, wherein the worksurface is a vehicle.

3. The robotic system of claim 2, wherein the region contains a defect, and wherein the surface engaging tool is a material removal tool.

4. The robotic system of claim 3, wherein the surface processing tool is a sander or polishing tool.

5. (canceled)

6. The robotic system of claim 1, wherein the trajectory is mapped onto the approximated surface.

7. The robotic system of claim 1, and further comprising:
approximating curvature at each of the sampled points in the region; and
wherein the approximated surface topography comprises the approximated curvature.

8. The robotic system of claim 7, wherein approximating curvature comprises sampling the approximated surface.

9. The robotic system of claim 1, and further comprising:
calculating the derivative of the approximated curvature at each of the sampled points; and
identifying a surface feature in the region based on the derivative calculation.

10. The robotic system of claim 2, wherein the trajectory is selected based on a defect size, defect location, defect type or defect severity.

11-14. (canceled)

15. A surface feature detection system for detecting a feature on a worksurface, the system comprising:
a surface sampling receiver that receives a plurality of surface samples from a surface imaging system;
a surface approximator that approximates the surface at each of the plurality of surface samples using an approximation;
a curvature approximator that approximates the curvature and derivative of curvature at each of the plurality of surface samples; and
a feature detector that, based on a derivative of the curvature approximation at each of the surface samples, identifies a point of zero-crossing in the derivative of curvature as a detected feature point.

16. (canceled)

17. The system of claim 15, wherein the detected feature is overlayed over the approximated surface or the sampled surfaces.

18-20. (canceled)

21. The system of claim 15, wherein the plurality of surface samples are within a radius of a target area on the worksurface.

22. The system of claim 21, wherein the worksurface is a vehicle surface, the target area comprises a defect, and wherein the surface feature is a valley, a ridge, an area of increased curvature, an area of convex curvature, an area of concave curvature, an area of rapid transition of convex and concave curvature on the vehicle surface proximate the defect.

23. (canceled)

24. The system of claim 15, and further comprising:
a repair evaluator that, based on the approximated curvature and approximated derivative of curvature, classifies an area as robotically repairable or not robotically repairable.

25-28. (canceled)

29. The robotic system of claim 15, wherein the modified trajectory includes a modified tool force, disk speed, or tool speed.

30. The robotic system of claim 15, wherein the trajectory template is selected based on a defect size, defect location, defect type or defect severity.

31. (canceled)

32. A method of removing material from a worksurface, the method comprising:
identifying a target area on the worksurface for material removal;
sampling a surface around the target area on the worksurface;
modeling the surface and, based on the model, detecting a surface topography;
modifying a surface processing trajectory based on the detected surface topography, wherein the surface processing trajectory comprises a movement path through the target area; and
transmitting a control signal to a robotic material removal system, wherein the control signal comprises the modified trajectory.

33. The method of claim 32, wherein modeling the surface comprises:
approximating the surface at each of a plurality of sampled surface locations.

34. (canceled)

35. The method of claim 32, wherein the target area comprises a defect.

36. (canceled)

37. (canceled)

38. The method of claim 32, wherein the modified movement path has a smaller area than the original movement path.

39. (canceled)

40. (canceled)
